(19) United States
(12) Patent Application Publication
(10) Pub. No.: US 2021/0130154 A1
(43) Pub. Date: May 6, 2021

(54) Fuel Delivery Tracking Assembly

(71) Applicant: Benjamin Justice, Roosevelt, UT (US)

(72) Inventor: Benjamin Justice, Roosevelt, UT (US)

(21) Appl. No.: 16/668,921

(22) Filed: Oct. 30, 2019

(51) Int. Cl. B67D 7/14; B67D 7/16; B67D 7/22; G06Q 50/06

(52) U.S. Cl. CPC B67D 7/145; B67D 7/16; G06Q 50/06; B67D 7/224; B67D 7/22

(57) ABSTRACT

A fuel delivery tracking assembly includes a fuel pumping unit that is fluidly coupled to a fuel tank for pumping fuel from the fuel tank. A monitoring unit is fluidly coupled to the fuel pumping unit. The monitoring unit records the flow of fuel through the fuel pumping unit for determining the fluid quantity of the fuel delivered from the fuel pumping unit. A data storage unit is included and the data storage unit is in wireless electrical communication with the monitoring unit. The data storage unit receives the fluid quantity of fuel delivered from the monitoring unit for the purposes of analysis and cost accounting with respect to the fuel delivered.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tracking device and more particularly pertains to a new tracking device for tracking fuel costs on remote work sites.

### (2) Description of Related Art Including Information Disclosed under 37 CFR 1.97 and 1.98

The prior art relates to tracking device.

### BRIEF SUMMARY OF THE INVENTION

An embodiment of the disclosure meets the needs presented above by generally comprising a fuel pumping unit that is fluidly coupled to a fuel tank for pumping fuel from the fuel tank. A monitoring unit is fluidly coupled to the fuel pumping unit. The monitoring unit records the flow of fuel through the fuel pumping unit for determining the fluid quantity of the fuel delivered from the fuel pumping unit. A data storage unit is included and the data storage unit is in wireless electrical communication with the monitoring unit. The data storage unit receives the fluid quantity of fuel delivered from the monitoring unit for the purposes of analysis and cost accounting with respect to the fuel delivered.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a fuel delivery tracking assembly according to an embodiment of the disclosure.

FIG. 2 is a perspective view of a monitoring unit and a data storage unit an embodiment of the disclosure.

FIG. 3 is a front view of an embodiment of the disclosure.

FIG. 4 is a back phantom view of an embodiment of the disclosure.

FIG. 5 is a detail view of taken from circle 5 of FIG. 2 of an embodiment of the disclosure.

FIG. 6 is a schematic view of an embodiment of the disclosure.

### DETAILED DESCRIPTION OF THE INVENTION

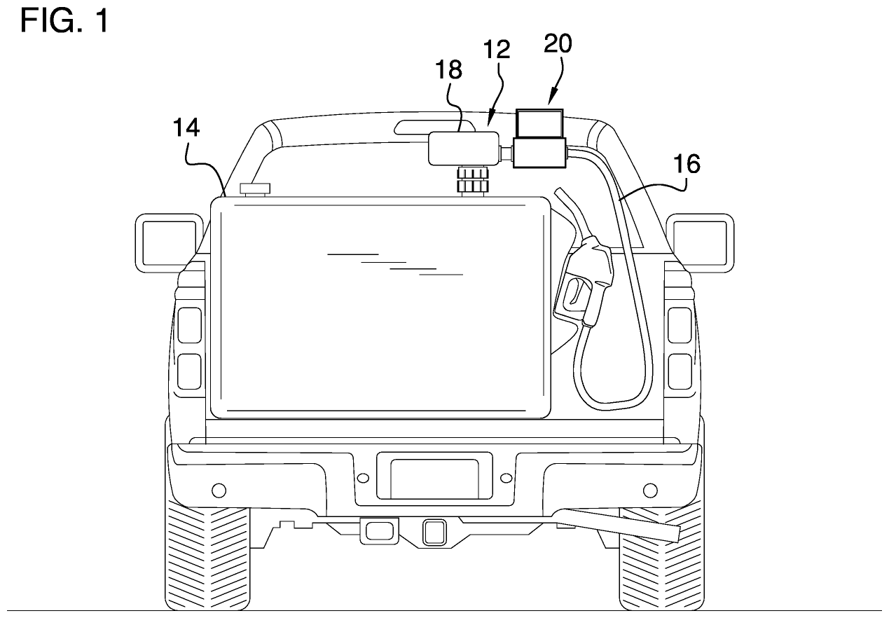

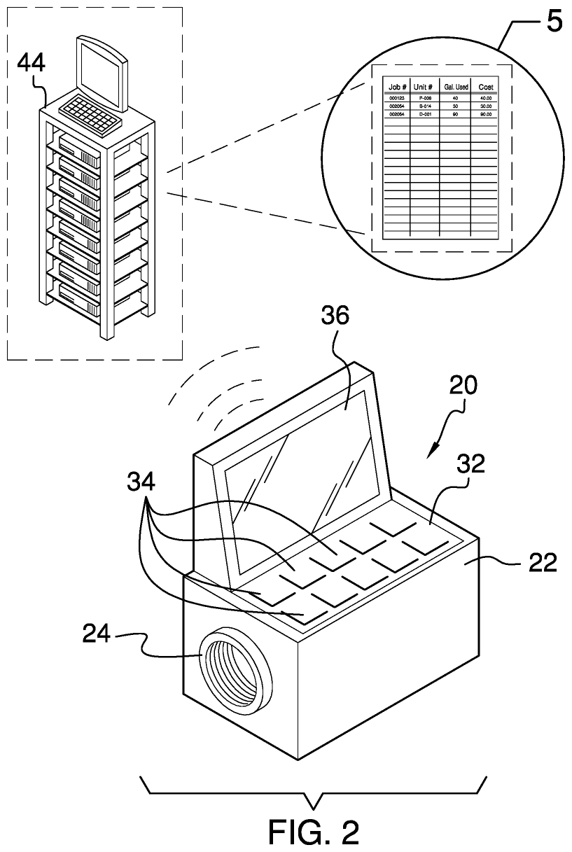

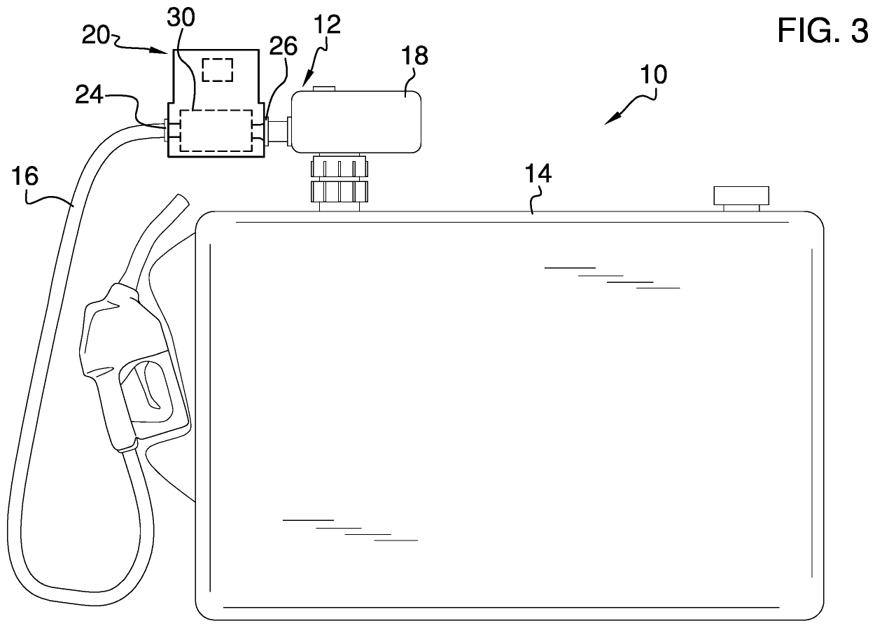

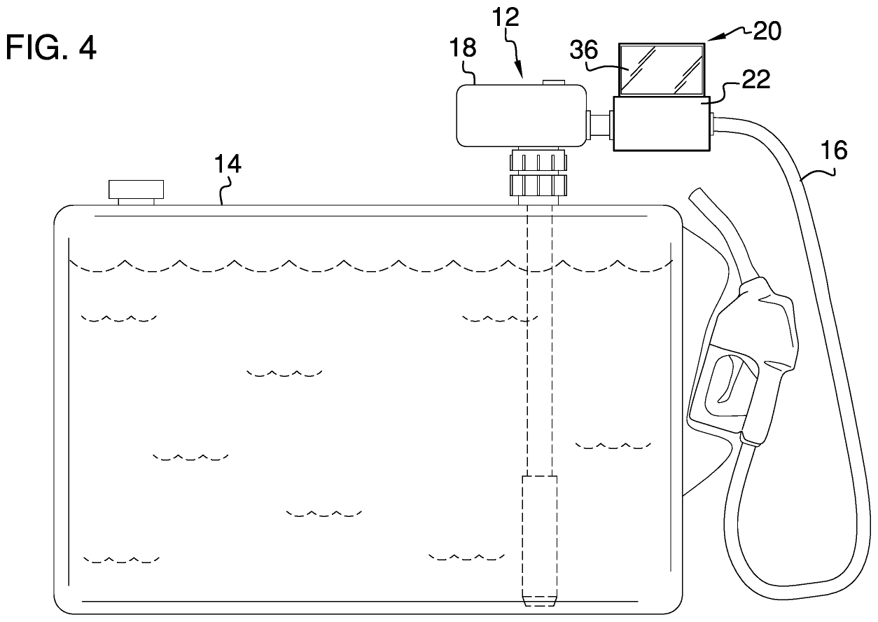

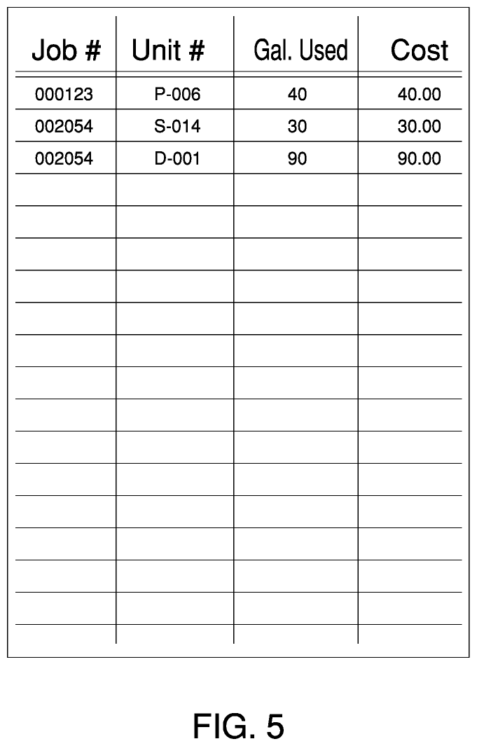

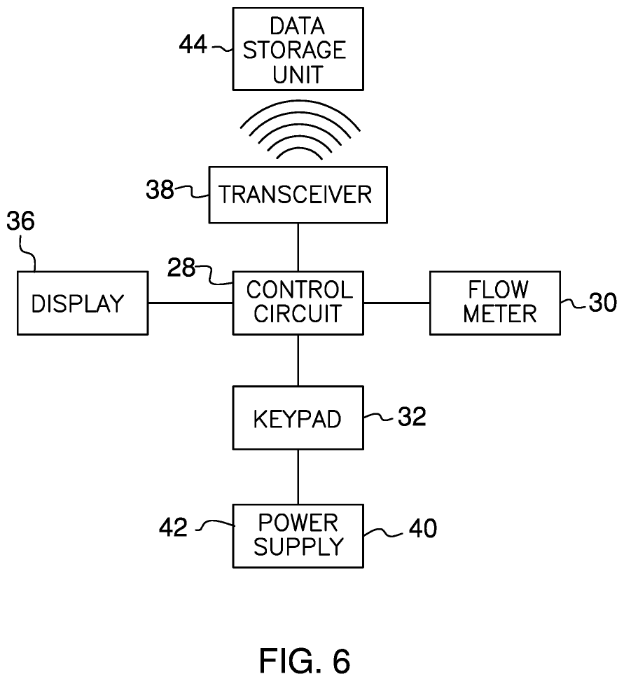

With reference now to the drawings, and in particular to FIGS. 1 through 6 thereof, a new tracking device embodying the principles and concepts of an embodiment of the disclosure and generally designated by the reference numeral 10 will be described.

As best illustrated in FIGS. 1 through 6, the fuel delivery tracking assembly 10 generally comprises a fuel pumping unit 12 that is fluidly coupled to a fuel tank 14. The fuel tank 14 may be a portable fuel tank that is positioned in the bed of a truck or other means of transportation. In this way the fuel pumping unit 12 can pump fuel from the fuel tank 14 in a remote location. The fuel pumping unit 12 includes a fuel hose 16 that is fluidly coupled to a fuel pump 18. The fuel pump 18 may be an electric fuel pump that is rated for pumping flammable, liquid fuel such as gasoline or the like.

A monitoring unit 20 is provided and the monitoring unit 20 is fluidly coupled to the fuel pumping unit 12. The monitoring unit 20 records the flow of fuel through the fuel pumping unit 12. In this way the monitoring unit 20 determines the fluid quantity of the fuel delivered from the fuel pumping unit 12. The monitoring unit 20 comprises a housing 22 that has an inlet 24 and an outlet 26. The inlet 24 is fluidly coupled to the fuel pump 18 for receiving the fuel that is pumped by the fuel pump 18. The outlet 26 is fluidly coupled to the fuel hose 16 for delivering the fuel pumped by the fuel pump 18 into the fuel hose 16 for delivery.

A control circuit 28 is positioned in the housing 22 and a flow meter 30 is positioned in the housing 22. The flow meter 30 is electrically coupled to the control circuit 28 and the flow meter 30 is in fluid communication with the outlet 26 in the housing 22. The flow meter 30 measures the flow of fuel through the housing 22 in a pre-determined unit of measurement. The flow meter 30 may be an electronic fluid flow meter and the pre-determined unit of measurement may be gallons or liters.

A keypad 32 is coupled to the housing 22 such that the keypad 32 is accessible to a user and the keypad 32 is electrically coupled to the control circuit 28. The keypad 32 includes a plurality of keys 34 that may comprise a Qwerty keyboard. A display 36 is coupled to the housing 22 and the display 36 is electrically coupled to the control circuit 28. The display 36 displays indicia comprising operational parameters of the fuel pump 18, including but not being limited to, the quantity of fuel delivered by the fuel pump 18. The display 36 may be an LCD or other type of electronic display.

A transceiver 38 is coupled to the housing 22 and the transceiver 38 is electrically coupled to the control circuit 28. The transceiver 38 may comprise a radio frequency transceiver or the like. A power supply 40 is provided and the power supply 40 is coupled to the housing 22. The power supply 40 is electrically coupled to the control circuit 28 and the power supply 40 comprises at least one battery 42.

A data storage unit 44 is provided and the data storage unit 44 is in wireless electrical communication with the monitoring unit 20. The data storage unit 44 receives the fluid quantity of fuel delivered from the monitoring unit 20 for the purposes of analysis and cost accounting with respect to the fuel delivered. Additionally, the data storage unit 44 is in electrical communication with the transceiver 38. The data storage unit 44 receives data from the keypad 32 with respect to job names, account numbers and other data pertaining to the fluid quantity of fuel delivered from the fuel pump 18. The data storage unit 44 may comprise a personal computer that is connected to the internet or other similar, remotely accessible data storage device.

In use, the fuel pump 18 is turned on the dispense fuel into construction equipment, jobsite vehicles or any other machinery that requires fuel for operation. The monitoring unit 20 tracks the quantity of fuel that is dispensed when the fuel pump 18 is turned on. Additionally, the keypad 32 is manipulated to enter pertinent information about the fuel dispensed, such as the name of the jobsite, the type of equipment that was refueled, and any other information useful for the purposes of cost accounting. Additionally, the information entered with the keypad 32, as well as the quantity of fuel dispensed is communicated to the data storage unit 44 for storage and analysis. In this way the fuel costs associated with the jobsite and the machinery can be accurately tracked for the purposes of cost accounting.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fuel delivery tracking assembly being configured to record fuel going into and out of a fuel tank for accounting purposes, said assembly comprising:
a fuel pumping unit being fluidly coupled to a fuel tank for pumping fuel from the fuel tank, said fuel pumping unit including a fuel hose being fluidly coupled to a fuel pump;
a monitoring unit being fluidly coupled to said fuel pumping unit, said monitoring unit recording the flow of fuel through said fuel pumping unit for determining the fluid quantity of the fuel delivered from said fuel pumping unit; and
a data storage unit, said data storage unit being in wireless electrical communication with said monitoring unit, said data storage unit receiving the fluid quantity of fuel delivered from said monitoring unit for the purposes of analysis and cost accounting with respect to the fuel delivered.

2. The assembly according to claim 1, wherein said monitoring unit comprises a housing having an inlet and an outlet, said inlet being fluidly coupled to said fuel pump for receiving the fuel that is pumped by said fuel pump, said outlet being fluidly coupled to said fuel hose for delivering the fuel pumped by said fuel pump into said fuel hose for delivery.

3. The assembly according to claim 2, wherein said monitoring unit includes a control circuit being positioned in said housing.

4. The assembly according to claim 3, further comprising a flow meter being positioned in said housing, said flow meter being electrically coupled to said control circuit, said flow meter being in fluid communication with said outlet in said housing, said flow meter measuring the flow of fuel through said housing in a pre-determined unit of measurement.

5. The assembly according to claim 4, further comprising a keypad being coupled to said housing such that said keypad is accessible to a user, said keypad being electrically coupled to said control circuit.

6. The assembly according to claim 5, further comprising a display being coupled to said housing, said display being electrically coupled to said control circuit, said display displaying indicia comprising operational parameters of said fuel pump, including but not being limited to, the quantity of fuel delivered by said fuel pump.

7. The assembly according to claim 3, further comprising a transceiver being coupled to said housing, said transceiver being electrically coupled to said control circuit, said transceiver.

8. The assembly according to claim 3, further comprising a power supply being coupled to said housing, said power supply being electrically coupled to said control circuit, said power supply comprising at least one battery.

9. The assembly according to claim 7, wherein said data storage unit is in electrical communication with said transceiver, said data storage unit receiving data from said keypad with respect to job names, account numbers and other data pertaining to the fluid quantity of fuel delivered from said fuel pump.

10. A fuel delivery tracking assembly being configured to record fuel going into and out of a fuel tank for accounting purposes, said assembly comprising:
a fuel pumping unit being fluidly coupled to a fuel tank for pumping fuel from the fuel tank, said fuel pumping unit including a fuel hose being fluidly coupled to a fuel pump;
a monitoring unit being fluidly coupled to said fuel pumping unit, said monitoring unit recording the flow of fuel through said fuel pumping unit for determining the fluid quantity of the fuel delivered from said fuel pumping unit, said monitoring unit comprising:
a housing having an inlet and an outlet, said inlet being fluidly coupled to said fuel pump for receiving the fuel that is pumped by said fuel pump, said outlet being fluidly coupled to said fuel hose for delivering the fuel pumped by said fuel pump into said fuel hose for delivery;
a control circuit being positioned in said housing;
a flow meter being positioned in said housing, said flow meter being electrically coupled to said control circuit, said flow meter being in fluid communication with said outlet in said housing, said flow meter measuring the flow of fuel through said housing in a pre-determined unit of measurement;
a keypad being coupled to said housing such that said keypad is accessible to a user, said keypad being electrically coupled to said control circuit;
a display being coupled to said housing, said display being electrically coupled to said control circuit, said display displaying indicia comprising operational parameters of said fuel pump, including but not being limited to, the quantity of fuel delivered by said fuel pump;
a transceiver being coupled to said housing, said transceiver being electrically coupled to said control circuit, said transceiver; and
a power supply being coupled to said housing, said power supply being electrically coupled to said control circuit, said power supply comprising at least one battery; and
a data storage unit, said data storage unit being in wireless electrical communication with said monitoring unit, said data storage unit receiving the fluid quantity of fuel delivered from said monitoring unit for the purposes of analysis and cost accounting with respect to the fuel delivered, said data storage unit being in electrical communication with said transceiver, said data storage unit receiving data from said keypad with respect to job names, account numbers and other data pertaining to the fluid quantity of fuel delivered from said fuel pump.
